(19) United States
(12) Patent Application Publication
(10) Pub. No.: US 2026/0243296 A1
(43) Pub. Date: Aug. 20, 2026

(54) APPARATUS FOR PREVENTING BOLT RELEASE AND ICE MAKING MACHINE INCLUDING THE SAME

(71) Applicant: BLUENIX Co., Ltd., Ansan-si, Gyeonggi-do (KR)

(72) Inventors: Doo Ha KIM, Anyang-si (KR); Min Soo JEONG, Incheon (KR)

(73) Assignee: BLUENIX Co., Ltd., Ansan-si, Gyeonggi-do (KR)

(21) Appl. No.: 19/251,265

(22) Filed: Jun. 26, 2025

(30) Foreign Application Priority Data
Feb. 18, 2025 (KR) 10-2025-0020503

(51) Int. Cl. F16B 41/00; F25C 5/20; G01D 11/30

(52) U.S. Cl. CPC F16B 41/002; F25C 5/24; G01D 11/30; F25C 2700/02

(57) ABSTRACT

The present disclosure provides an apparatus for preventing bolt release including a first fastening portion in which a first coupling hole is formed, and a second fastening portion in which a second coupling hole is formed, such that bolt heads are coupled one by one; and a connection portion elastically connecting the first and second fastening portions, and an ice making machine including the same.

### CROSS-REFERENCE TO RELATED APPLICATIONS

This application claims benefit of priority to Korean Patent Application No. 10-2025-0020503 filed on Feb. 18, 2025 in the Korean Intellectual Property Office, the disclosure of which is incorporated herein by reference in its entirety.

### BACKGROUND

### 1. Field

The present disclosure relates to an apparatus for preventing bolt release capable of preventing releasing of a bolt for fixing a bracket, and an ice making machine including the same.

### 2. Description of Related Art

An ice making machine may be a device for making ice, and may be a device supplying water, freezing the same in an ice-making unit to make ice, collecting the ice in a storage portion, and allowing a user to remove the ice contained in the storage portion, when necessary.

Since such an ice making machine may have stability problems when the storage portion is full of ice and ice further continues to be made, a sensor may be installed to sense if the storage portion is full of ice in order to prevent any more ice from being made when the storage portion is full.

Such a sensor may be usually mounted using a bracket, and may be installed by fixing the bracket to a head portion of the ice making machine with a bolt.

When the ice making machine is operated to make ice in a state in which the sensor is installed in this manner, the made ice may fall into the storage portion. At this time, at least some of the falling ice may hit the sensor or the bracket.

At this time, in addition to vibrations caused by operation of the ice making machine, a fastened state of a bolt may loosen, or, in severe cases, a bolt may fall into the storage portion due to the ice hitting the sensor or the bracket.

### SUMMARY

According to an embodiment of the present disclosure, an apparatus for preventing bolt release, coupled to a bolt head for fixing a bracket to prevent a bolt from releasing and falling due to external vibrations or impacts, may be provided.

According to another embodiment of the present disclosure, an ice making machine preventing a bolt for fixing a sensor unit sensing fullness of ice in the ice making machine from releasing and falling into a storage portion, may be provided.

Problems of the present disclosure are not limited to the above-described contents. Anyone with ordinary knowledge in the technical field to which the present disclosure pertains will have no difficulty in understanding additional tasks of the present disclosure from overall contents of the present specification.

An apparatus for preventing bolt release according to an embodiment of the present disclosure may include a first fastening portion in which a first coupling hole is formed, and a second fastening portion in which a second coupling hole is formed, such that bolt heads are coupled one by one; and a connection portion elastically connecting the first and second fastening portions.

In an embodiment of the present disclosure, the first and second fastening holes may be formed as holes having a shape having the number of angles, greater than the number of angles of each of the bolt heads.

In an embodiment of the present disclosure, the apparatus for preventing bolt release may further include a handle portion extending from the connection portion.

In an embodiment of the present disclosure, a size of the first coupling hole and a size of the second coupling hole may respectively be smaller than a size of each of the bolt heads.

In an embodiment of the present disclosure, the first and second fastening portions and the connection portion may be formed of rubber or silicone.

In an embodiment of the present disclosure, the first and second fastening portions and the connection portion may have colors that are distinguishable from ice.

According to another aspect of the present disclosure, an ice making machine including a head portion including an ice-making unit; a storage portion disposed below the head portion, and in which ice produced by the ice-making unit is stored; and a sensor unit installed on a passage through which ice falls from the head portion, and sensing whether the storage portion is full of ice, wherein the sensor unit includes a full sensor; a bracket having a first bolt hole and a second bolt hole, formed to be spaced apart from each other, and fixed to the head portion by bolts respectively fastened to the first and second bolt holes; and an apparatus for preventing bolt release including a first fastening portion and a second fastening portion, in which a first coupling hole and a second coupling hole, coupled one by one to bolt heads, are formed, and a connection portion elastically connecting the first and second fastening portions, may be provided.

In an embodiment of the present disclosure, a gap between centers of the first and second coupling holes of the apparatus for preventing bolt release may be smaller than a gap between centers of the bolt heads located to be spaced apart from each other.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view illustrating an ice making machine to which an apparatus for preventing bolt release according to an embodiment of the present disclosure is applied.

FIGS. 2 and 3 are perspective views illustrating the internal structure of a head portion of the ice making machine of FIG. 1.

FIG. 4 is an enlarged perspective view illustrating the sensor unit of FIG. 2.

FIG. 5 is a partially cutaway perspective view illustrating a state in which a sensor unit is installed in a head portion.

FIG. 6 is a perspective view illustrating the apparatus for preventing bolt release of FIG. 4.

FIG. 7 is a perspective view illustrating a sensor unit from which the apparatus for preventing bolt release is removed, in FIG. 4.

FIGS. 8 to 10 are views illustrating a process of installing a sensor unit to a head portion.

### DETAILED DESCRIPTION

Hereinafter, preferred embodiments of the present disclosure will be described with reference to the attached drawings. However, embodiments of the present disclosure may be modified in various different forms, and the scope of the present disclosure is not limited to embodiments described below.

In addition, embodiments of the present disclosure may be provided to more completely explain the present disclosure to a person having average knowledge in the relevant technical field. In the drawings, shapes, sizes, or the like of elements may be exaggerated for clarity.

In describing embodiments of the present disclosure, when it is judged that a specific description of known technologies related to the present disclosure may unnecessarily obscure the gist of the present disclosure, the detailed description thereof will be omitted.

In addition, the terms described below may be terms defined in consideration of their functions in the present disclosure, and these may vary depending on the intention, custom, or the like of the user or operator. Therefore, the definitions should be made based on the contents throughout the present specification.

The terms used in the detailed description may be only for describing the embodiments of the present disclosure, and should never be limited. Unless clearly used otherwise, expressions in the singular form include plural meanings.

In the present description, expressions such as “including” or “having” may be intended to indicate certain features, numbers, steps, operations, elements, portions or combinations thereof, and should not be construed to exclude the presence or possibility of one or more other features, numbers, steps, operations, elements, portions or combinations thereof other than those described.

In the present specification, terms such as “on,” “upper,” “upper portion,” “upper surface,” “below,” “lower,” “lower portion,” “lower surface,” “side surface,” or the like may be based on the drawings, and may actually vary depending on a direction in which elements or components are disposed.

In addition, throughout the specification, when a portion is said to be “connected” to another portion, this may include not only cases in which it may be “directly connected,” but also cases in which it may be “indirectly connected” with another element interposed therebetween.

Hereinafter, the present disclosure will be described in detail through each embodiment or example of the present disclosure. It should be noted that each embodiment or example described in the present specification is not limited to a single embodiment or example, but may be combined with other embodiments or examples.

Therefore, citation of a claim in the scope of the patent claims may be only an example of an embodiment, and the technical idea of the present disclosure should not be interpreted only as a combination with the cited claim, and the combination with various claims may be also included in the scope of the technical idea of the present disclosure.

An apparatus for preventing bolt release according to an embodiment of the present disclosure may be a tool preventing releasing of a plurality of bolts by being forcedly fitted into bolt heads of a bracket in which the bolts are fastened at a predetermined gap and fixed to a target fixed object, and may include first and second fastening portions in which first and second fastening holes are formed such that the bolt heads fastened to the bracket at a predetermined gap are coupled one by one, and a connection portion elastically connecting the first and second fastening portions.

Hereinafter, the present disclosure will be specifically described through examples. However, it should be noted that the examples described below may be only intended to illustrate and concretize the present disclosure, and may not be intended to limit the scope of the rights of the present disclosure. This may be because the scope of the rights of the present disclosure may be determined by matters described in the patent claims and matters reasonably inferred therefrom.

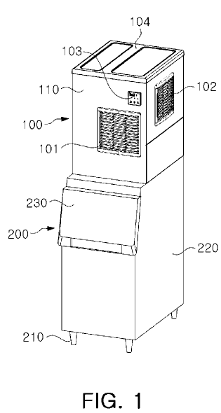

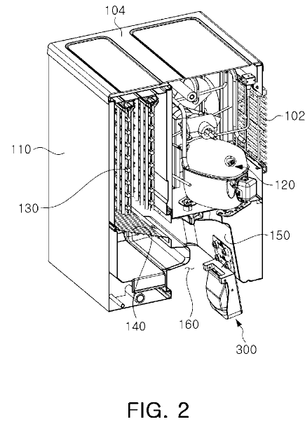

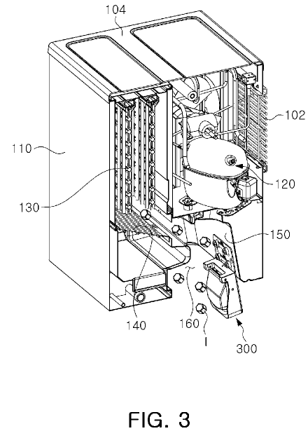

FIG. 1 is a perspective view illustrating an ice making machine to which an apparatus for preventing bolt release according to an embodiment of the present disclosure is applied, and FIGS. 2 and 3 are perspective views illustrating the internal structure of a head portion of the ice making machine of FIG. 1.

Referring to FIGS. 1 to 3, an ice making machine 1 to which an apparatus 400 for preventing bolt release of an embodiment is applied may be a modular ice making machine, and may include a head portion 100, a storage portion 200, and a sensor unit 300. Figure symbol “210” indicates a leg for supporting the ice making machine 1 on a floor.

The ice making machine 1 may include a control unit (not illustrated) for controlling an operation of the sensor unit 300 and an operation of an ice-making unit.

The control unit may be wirelessly or wiredly connected to a full sensor 310 of the sensor unit 300 and the ice-making unit of the head portion 100, and may perform roles of turning on/off or appropriately controlling an operation of the full sensor 310 and an operation of the ice-making unit. In an embodiment, the control unit may use a control unit of a known ice making machine, and therefore, a detailed description of such a control unit will be omitted in the present disclosure.

The head portion 100 may be a portion for making ice, and may be equipped with the ice-making unit receiving an appropriate amount of water from a water supply unit 120, and making ice.

The ice-making unit may include components such as a water supply unit compressor, a condenser, an expander, an evaporator, or the like, to configure a refrigeration cycle, and the ice-making unit may use a configuration of a known modular ice making machine, and therefore, a detailed description of the ice-making unit will be omitted in the present disclosure.

In addition, the head portion 100 may be provided with at least one ventilation hole (101 and 102) such that air is ventilated therein to cool heat of the ice-making unit 130.

In addition, the head portion 100 may be provided with a controller 103 linking with the control unit and configured to control an operation of an ice generating unit 130 of the ice-making unit and an operation of an ice making machine driving unit 120 by an on/off operation.

In addition, a cover 104 may be coupled to an upper end of the head portion 100 such that an internal space of the head portion 100 may be exposed, and a slide 140 may be disposed on a lower side of the ice generating unit 130 such that generated ice I may slide and move in a downward direction through an opening 160.

The storage portion 200 may be disposed below the head portion 100, and may be a portion having a receiving space 220 in which ice I generated from the ice generating unit 130 of the head portion 100 falls in a downward direction, accumulates, and is stored.

In addition, a door 230 for withdrawing received ice may be installed in the storage portion 200. As another example, a dispenser (not illustrated) may be provided in the storage portion 200 such that ice may be withdrawn without exposing a separate door 230.

In this case, a lower end of the head portion 100 and an upper end of the storage portion 200 may be configured to have the opening 160 exposing to and communicating with each other such that ice I falls.

Therefore, the ice I generated by the ice generating unit 130 of the head portion 100 may fall in a downward direction through the opening 160 along the slide 140, and may be accumulated and stored in the storage portion 200.

The sensor unit 300 may be installed on a passage through which ice falls from the head portion 100, may be located on a lower end of the head portion 100, and may be installed to protrude from the lower end of the head portion 100 in a downward direction by a predetermined length such that a portion thereof hangs over an upper side of the storage portion 200.

The sensor unit 300 may sense if the storage portion 200 is full of ice, and may control the ice making machine through the control unit such that ice is no longer generated in the ice generating unit 130.

For example, when the storage portion 200 is filled with ice and uppermost ice touches the full sensor 310 of the sensor unit 300, the control unit linked to the sensor unit 300 may determine as being full and may turn off the ice making machine driving unit 120 of the head portion 100 to stop an ice production operation of the ice generating unit 130.

Afterwards, when the ice I is taken out of the storage portion 200 and does not touch the full sensor 310, the control unit may determine that there is room in the receiving space of the storage portion 200 again, and may operate the ice making machine driving unit 120 again.

In addition, the sensor unit 300 may include a full sensor 310, a bracket 320, and an apparatus 400 for preventing bolt release.

The full sensor 310 may be located such that a lower end thereof is located at a height corresponding to a full ice height of the storage portion 200.

The full sensor 310 may be in contact with the ice I located on an uppermost end of the storage portion 200 when the storage portion 200 is full of ice I, to sense full ice of the storage portion 200.

In this case, the full sensor 310 may send sensing of full ice to the control unit, and the control unit may turn off an operation of the ice making machine to stop ice production.

The bracket 320 may be fixed to a support portion 150 of the head portion 100 to mount the full sensor 310 to the head portion 100, and the full sensor 310 may be attached to a lower portion of the bracket 320. In this case, a fixing plate 155 for fixing a bolt 355 in a position corresponding to the bracket 320 may be closely disposed on an outer side surface of an inner side portion of the support portion 150 in the head portion 100.

In addition, the bracket 320 may have first and second bolt holes 331 and 332 formed to be spaced apart from each other in left and right directions, and may be fixed to the head portion 100 by bolts fastened to the first and second bolt holes 331 and 332, respectively.

In this case, to further strengthen a coupled state of the bracket 320, a plurality of bolts may be fastened in a vertical direction, and thus, two or more pairs of the first bolt hole 331 and the second bolt hole 332 may be formed in the vertical direction.

The first and second bolt holes 331 and 332 may include first and second penetration portions 331a and 332a formed larger than a size of a bolt head 350, and first and second slot portions 331b and 332b cut in an upward direction from the first and second penetration portions 331a and 332a by a predetermined length.

The first and second slot portions 331b and 332b may be formed to be smaller than the bolt head 350 and larger than a body 355 of a bolt.

In addition, a rivet hole (351 and 352) formed in a slit shape in the vertical direction may be formed in the bracket 320. A head of the rivet 151 may be located in the rivet hole (351 and 352) to prevent the bracket 320 from being lifted from the inner side portion of the support portion 150 by the rivet 151 and to ensure close contact with the bracket 320.

In the ice making machine 1, during ice removal, the ice I may slide through the slide 140, and may continuously fall in a downward direction toward the storage portion 200 while hitting the full sensor 310.

In this case, the bolt fixing the bracket 320 may unexpectedly loosen, or may be, in severe cases, released due to vibrations generated during the operation of the ice making machine 1 or impacts generated while the ice I hits the full sensor 310 or the bracket 320 multiple times.

When a bolt is completely released in this manner, the bolt will fall in the storage portion 200 together with the ice I, and while taking out and drinking the ice I, there is a possibility that the bolt will be taken out together with and mixed with the ice I into the cup, and there may be a risk that a user may accidentally ingest the bolt, resulting in serious danger.

In an ice making machine 1 of an embodiment, the sensor unit 300 sensing if the storage portion 200 of the ice making machine 1 is full of ice may be installed in the head portion 100, and the sensor unit 300 may be fixed to the support portion 150 of the head portion 100 by the bracket 320. In this case, the apparatus 400 for preventing bolt release may be coupled to the bolt head 350 of the bolt for fixing the bracket 320 to the head portion 100, such that even though vibration occurs during an operation of the ice making machine 1 or an impact occurs due to ice falling, the bolt may be prevented from loosening or releasing, thereby preventing the bolt from unexpectedly falling in the storage portion 200.

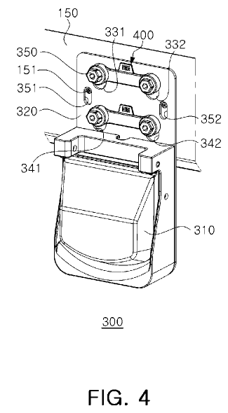

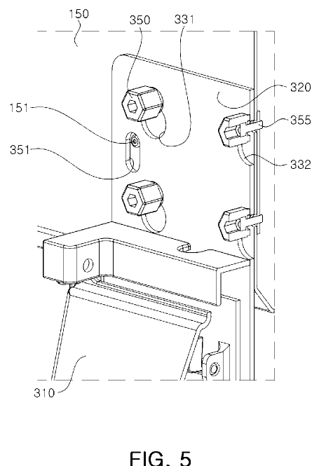

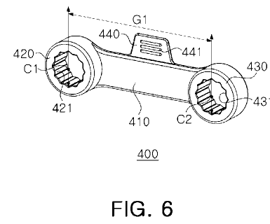

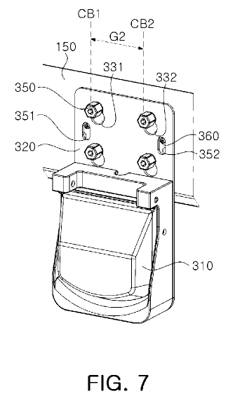

FIG. 4 is an enlarged perspective view illustrating the sensor unit of FIG. 2, FIG. 5 is a partially cutaway perspective view illustrating a state in which a sensor unit is installed in a head portion, FIG. 6 is a perspective view illustrating the apparatus for preventing bolt release of FIG. 4, and FIG. 7 is a perspective view illustrating a sensor unit from which the apparatus for preventing bolt release is removed, in FIG. 4.

Hereinafter, an apparatus for preventing bolt release according to an embodiment of the present disclosure will be described in more detail.

Referring to FIGS. 4 to 7, an apparatus 400 for preventing bolt release according to an embodiment may be a tool in which, in a bracket 320 in which a plurality of bolts are fastened at a predetermined gap and fixed to a target fixed object (support portion 150), two bolt heads 350 located at a predetermined gap in the left and right directions may be forcedly fitted and connected, respectively, and two bolts may be elastically connected to each other in the left and right direction to prevent releasing of the bolts due to external impact such as vibration caused by an operation of an ice making machine 1 or collision with ice.

The apparatus 400 for preventing bolt release may include first and second fastening portions 420 and 430 and a connection portion 410.

First and second coupling holes 421 and 431 may be formed in the first and second fastening portions 420 and 430 such that the bolt heads 350 of the two bolts fastened to the support portion 150 at a predetermined gap in the left and right directions may be forcedly fitted and coupled one by one.

The connection portion 410 may connect the first and second fastening portions 420 and 430 in a belt manner in the left and right directions, and may elastically connect the first and second fastening portions 420 and 430 such that tension may be maintained on the first and second fastening portions 420 and 430.

In addition, the apparatus 400 for preventing bolt release may be formed of an elastic material for elastically connecting the two bolts located at a predetermined gap in the left and right directions using the connection portion 410.

In addition, the apparatus 400 for preventing bolt release may be formed in a specific color to be easily identified with a naked eye even when the apparatus 400 falls into the storage portion 200. For example, the apparatus 400 for preventing bolt release may be formed in a ‘red’ color to be easily identified when the apparatus 400 is disposed in the storage portion 200 together with ice.

In addition, a size of each of the first and second coupling holes 421 and 431 may be formed to be smaller than a size of the bolt head 350 to be coupled. An inner diameter of each of the first and second coupling holes 421 and 431 may be formed to be smaller than an outer diameter of the bolt head 350.

Therefore, the bolt head 350 may be forcedly fitted into the first and second coupling holes 421 and 431 respectively such that the bolt head 350 may be prevented from being easily removed from the first and second fastening portions 420 and 430, and a state in which the apparatus 400 for preventing bolt release is coupled to the bolt may be maintained more firmly.

In addition, the bolt head 350 may be formed in a polygonal shape to be easy to hold and turn with a hand or a tool, when the bolt is fastened to the target fixed object (support portion 150).

Therefore, the first and second coupling holes 421 and 431 may be formed in a protruding shape in which convex and concave portions are alternately formed. For example, the first and second coupling holes 421 and 431 may be formed in a polygonal shape such that the bolt head 350 having a polygonal shape is easy to be forcedly fitted thereinto.

Since a position of the bolt head 350 does not always symmetrical in the left and right directions, to more easily forcedly fit the bolt head 350 into the first and second coupling holes 421 and 431, shapes of the first and second coupling holes 421 and 431 may be formed as holes having a shape having the number of angles, greater than the number of angles of the bolt head 350.

As an example, the first and second coupling holes 421 and 431 may be formed as holes having a shape having the number of angles twice the number of angles of the bolt head 350. For example, when a bolt having a hexagonal shape is used as the bolt head 350, the first and second coupling holes 421 and 431 may be formed as holes having a dodecagonal shape.

In addition, the connection portion 410 may be formed to have a distance such that a gap G1 between a center C1 of the first coupling hole 421 and a center C2 of the second coupling hole 431 is smaller than a gap G2 between a center CB1 of the bolt head 350 connected to the first coupling hole 421 and a center CB2 of the bolt head 350 connected to the second coupling hole 431.

Therefore, when the first and second coupling holes 421 and 431 of the apparatus 400 for preventing bolt release are forcedly fitted into the bolt heads 350 of the two bolts located in the left and right directions, respectively, tension between the first and second fastening portions 420 and 430 may increase, such that a state in which the bolt heads 350 are forcedly fitted into the first and second fastening portions 420 and 430 may be maintained more firmly.

Therefore, the apparatus 400 for preventing bolt release may be more effectively prevented from being separated from the bolt head 350, and vibration or shock transmitted to the bolt may be reduced, thereby effectively preventing the bolt from being released from the target fixed object.

In addition, the apparatus 400 for preventing bolt release may further include a handle portion 440.

The handle portion 440 may be a portion extending by a predetermined area from one edge of the connection portion 410.

In some cases, the apparatus 400 for preventing bolt release needs to be separated from the bolt head 350 due to various reasons such as cleaning, maintenance, or the like, and the handle portion 440 may assist in easily separating the apparatus 400 for preventing bolt release from the bolt head 350 when a user grabs and pulls it.

In this case, at least one anti-slip protrusion 441 may be formed on a surface of the handle portion 440 to increase friction.

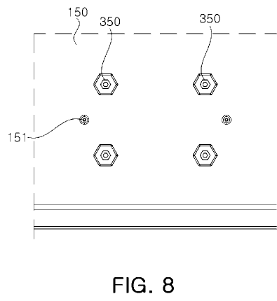

FIGS. 8 to 10 are views illustrating a process of installing a sensor unit to a head portion.

In explaining a process of installing a sensor unit 300 on a head portion 100, first, as in FIGS. 5 and 8, a bolt may be fastened to an inner side surface of a support portion 150 in a state in which a fixing plate 155 is disposed on an outer side surface of the support portion 150 of the head portion 100.

In this case, the bolt may not be completely tightened, but may be loosely tightened to an extent that a bolt head 350 is not in close contact with the support portion 150, and, separately from the bolt 355, a rivet 151 may be fastened, such that even though the bolt 355 is not completely tightened, the fixing plate 155 may be firmly attached to the outer side surface of the support portion 150 without shaking.

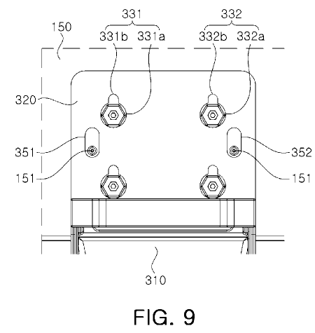

Next, as in FIG. 9, a bracket 320 equipped with a full sensor 310 may be installed on the inner side surface of the support portion 150.

In this case, bolt heads 350 may be located in first and second penetration portions 331a and 332a of first and second bolt holes 331 and 332, and rivets 151 may be located on lower sides of rivet holes 351 and 352.

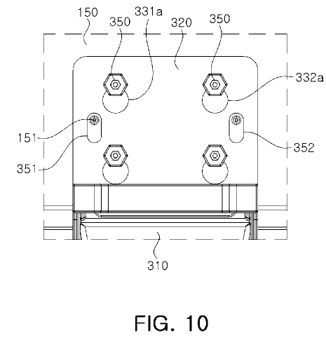

Next, as illustrated in FIG. 10, when the bracket 320 moves in the downward direction, a bolt body 355 may be forcedly fitted into first and second slot portions 331b and 332b of the first and second bolt holes 331 and 332, and heads of the rivets 151 may be located on upper sides of the rivet holes 351 and 352.

In this state, when the bolt head 350 is turned to tighten the bolt, the bracket 320 may be firmly coupled without moving from the support portion 150.

Then, first and second coupling holes 421 and 431 of first and second fastening portions 420 and 430 may be forcedly fitted into a pair of bolt heads 350 located in the left and right directions, to install an apparatus 400 for preventing bolt release.

An apparatus for preventing bolt release according to an embodiment of the present disclosure may be coupled to a bolt head used in fixing a bracket to a target fixed object, to prevent a bolt from being unexpectedly separated due to external vibrations or impacts.

In addition, a sensor unit sensing if a storage portion of an ice making machine is full of ice may be installed in a head portion, and the sensor unit may be fixed to the head portion by a bracket. In this case, when an apparatus for preventing bolt release is coupled to the bolt head for fixing the bracket to the head portion, even though the ice directly hits a bolt during vibration or ice drop during an operation of the ice making machine, a problem that the bolt is loosed or released may be prevented to prevent a problem that the bolt unexpectedly falls into the storage portion.

While example embodiments have been illustrated and described above, it will be apparent to those skilled in the art that modifications and variations could be made without departing from the scope of the present disclosure as defined by the appended claims.

What is claimed is:

1. An apparatus for preventing bolt release comprising:
a first fastening portion in which a first coupling hole is formed, and a second fastening portion in which a second coupling hole is formed, such that bolt heads are coupled one by one; and
a connection portion elastically connecting the first and second fastening portions.

2. The apparatus of claim 1, wherein the first and second coupling holes are formed as holes having a shape having the number of angles, greater than the number of angles of each of the bolt heads.

3. The apparatus of claim 1, further including a handle portion extending from the connection portion.

4. The apparatus of claim 1, wherein a size of the first coupling hole and a size of the second coupling hole are respectively smaller than a size of each of the bolt heads.

5. The apparatus of claim 1, wherein the first and second fastening portions and the connection portion are formed of rubber or silicone.

6. The apparatus of claim 1, wherein the first and second fastening portions and the connection portion have colors that are distinct from ice.

7. An ice making machine comprising:
a head portion including an ice-making unit;
a storage portion disposed below the head portion, and in which ice produced by the ice-making unit is stored; and
a sensor unit installed on a passage through which ice falls from the head portion, and sensing whether the storage portion is full of ice,
wherein the sensor unit includes:
a full sensor;
a bracket having a first bolt hole and a second bolt hole, formed to be spaced apart from each other, and fixed to the head portion by bolts respectively fastened to the first and second bolt holes; and
an apparatus for preventing bolt release including a first fastening portion and a second fastening portion, in which a first coupling hole and a second coupling hole, coupled one by one to bolt heads, are formed, and a connection portion elastically connecting the first and second fastening portions.

8. The ice making machine of claim 7, wherein a gap between centers of the first and second coupling holes of the apparatus for preventing bolt release is smaller than a gap between centers of the bolt heads located to be spaced apart from each other.

9. The ice making machine of claim 7, wherein the full sensor is located at a height corresponding to a full ice height of the storage portion.

10. The ice making machine of claim 7, wherein the apparatus for preventing bolt release is formed in two or more pairs of the first and second bolt holes in upward and downward directions of the ice making machine.

11. The ice making machine of claim 7, wherein, in the apparatus for preventing bolt release, the first and second coupling holes are formed as holes having a shape having the number of angles, greater than the number of angles of each of the bolt heads.

12. The ice making machine of claim 7, wherein the apparatus for preventing bolt release further includes a handle portion extending from the connection portion.

13. The ice making machine of claim 7, wherein, in the apparatus for preventing bolt release, a size of the first coupling hole and a size of the second coupling hole are respectively smaller than a size of each of the bolt heads.

14. The ice making machine of claim 7, wherein, in the apparatus for preventing bolt release, the first and second fastening portions and the connection portion are formed of rubber or silicone.

15. The ice making machine of claim 7, wherein, in the apparatus for preventing bolt release, the first and second fastening portions and the connection portion have colors that are distinct from ice.
